(19) United States
(12) Patent Application Publication
(10) Pub. No.: US 2014/0030693 A1
(43) Pub. Date: Jan. 30, 2014

(54) METHOD AND DEVICE FOR REAL TIME EXPRESSION

(71) Applicant: Joseph Dynlacht, Indianapolis, IN (US)

(72) Inventor: Joseph Dynlacht, Indianapolis, IN (US)

(21) Appl. No.: 13/951,366

(22) Filed: Jul. 25, 2013

Related U.S. Application Data
(60) Provisional application No. 61/675,912, filed on Jul. 26, 2012.

(51) Int. Cl. G09B 25/00

(52) U.S. Cl. CPC G09B 25/00
USPC 434/408

(57) ABSTRACT

Methods and devices for real time expression at an event. In one embodiment, an article includes an image of a figure, entity, or individual and an expression area including a rewritable surface. In another embodiment, a method includes the steps of displaying an article including an image of a figure, entity, or individual, where the article also includes an expression area with a rewritable surface, displaying the article in a public or private event, where a figure, entity, or individual is participating in the event, and expressing a sentiment in the expression area.

### CROSS-REFERENCE TO RELATED APPLICATIONS

This application claims the benefit of U.S. Provisional Ser. No. 61/675,912, filed Jul. 26, 2012, titled The Talking Bighead, the disclosure of which is expressly incorporated by reference.

### BACKGROUND OF THE INVENTION

It is customary for people attending public events, for example, sporting events, to carry images of notable figures, for example sports stars, celebrities, famous people, participants of the public event, and other similarly situated individuals or entities. By carrying the images, statements are being made about the notable figure and the holder of the notable figure. Typically the holder of the image is making a statement either in support or in criticism of the notable figure.

(1) Field of the Invention

The current disclosure relates to methods and devices for real time expression at a public or private event.

(2) Description of Related Art

The images carried to public or private events may include large images, such as head shots of a notable figure. The holder of the image may have had several images of notable figures to choose from prior to the event. As the images may be large, it can be difficult to carry several images to a public event. The holder of the image may have selected one or more images of at least one notable figure to display at the event. The holder of the image may have had to choose to carry less than all of the images due to the size of the images or regulations of the venue. There is an inherent limit to the kinds and types of statements a holder of the image can make with a limited number of images to display at the event. There are also additional inherent limitations to the kinds and types of statements the holder of the image can make due to the number and types of images of the notable figure that are available to display at the event.

There are also additional inherent limitations to the kinds and types of statements a holder of the image can make due to the real time nature of the event. Carrying only the images themselves does not provide the person carrying the images with an opportunity to express, in real time, the holder's thoughts, words, or illustrations; for example, criticism or support, about the notable figure, entities, the event or the venue For example, a player participating in a sporting event makes a great play. A holder of the image of the player displays the image for all participants of the event to see, and may want to also express positive sentiments. Later during the event, a referee makes a horrible call involving that player. The holder of the image may want to express criticism or displeasure with the referee. However the image of the player alone may not facilitate the holder's desire to express praise, criticism or displeasure.

### BRIEF SUMMARY OF THE INVENTION

An article comprising an image of a figure, entity, or individual and an expression area including a rewritable surface.

A method comprising the steps of displaying an article including an image of a figure, entity, or individual, where the article also includes an expression area with a rewritable surface, displaying the article at an event where the figure, entity, or individual is participating in the event, and expressing a sentiment in the expression area.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1 is a front view of an expression image which includes an image area and an expression according to embodiment of the present disclosure.

FIG. 2 is a front view of the expression image shown in FIG. 1 with an alternative expression and further including a dry erase marker and a dry eraser.

FIG. 3 is a rear view of the expression image of FIG. 1 which illustrates a panel supporting the image and the expression.

FIG. 4a is a perspective view of a person holding an expression image at sporting event with an expression in support of a sport star participating in the sporting event.

FIG. 4b is a perspective view of a person holding an expression image at sporting event with an alternative expression in criticism of a sport star participating in the sporting event.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

Wherever appropriate, any mention of plurality in this description of embodiments includes singulars and any mentions of the singulars also include plurals.

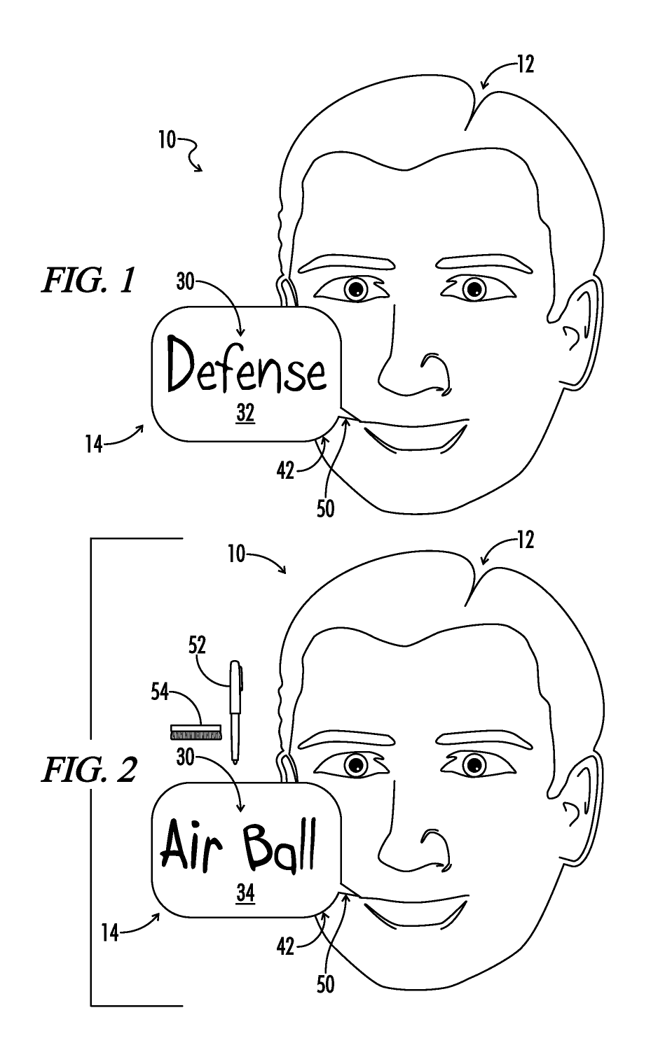

Referring to FIG. 1 expression image 10 displays image 12 and expression 14. Image 12 may include a drawing, figure, form, icon, illustration, likeness, photograph, picture, portrait, reflection, reproduction, and/or similitude of a FIG. 16, entity 18, or individual 20.

Expression 14 is illustrated as a speech bubble (also known as a talking bubble, speech balloon, dialogue balloon, and/or word balloon). A speech bubble depicts that FIG. 16, entity 18, or individual 20 in image 12 is saying the words or phrases on expression 14.

It is also envisioned that expression 14 may be illustrated as a thought bubble, fuzzy bubble, mental picture, exclamation bubble, and/or daydream. A thought bubble depicts that FIG. 16, entity 18, or individual 20 in image 12 is thinking what is written or depicted on expression 14. An exclamation bubble depicts that FIG. 16, entity 18, or individual 20 on image 12 is exclaiming the words/phrases on expression 14.

It is also envisioned that expression 14 may be illustrated as a caption. A caption depicts a title, short explanation, or description accompanying image 12. For example, a caption may include a series of words superimposed below image that communicate an overall narrative.

Expression area 30 comprises an erasable or re-writeable surface 32. In another embodiment of the present disclosure, expression area 30 of expression image 10 may be comprised of dry erase surface 34. Holder 62 may choose to include an announcement, argument, assertion, articulation, commentary, communication, declaration, delivery, elucidation, emphasis, explanation, exposition, idiom, interpretation, issue, language, mention, narration, phrase, pronouncement, remark, rendition, speech, statement, vent, voice, and/or word as expression 14 on dry erase surface 34 that may depict actions or thoughts of FIG. 16, entity 18, or individual 20.

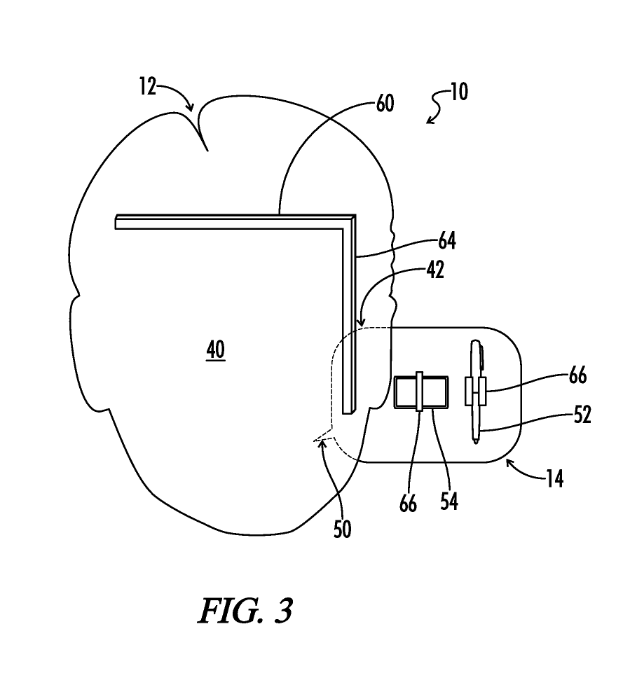

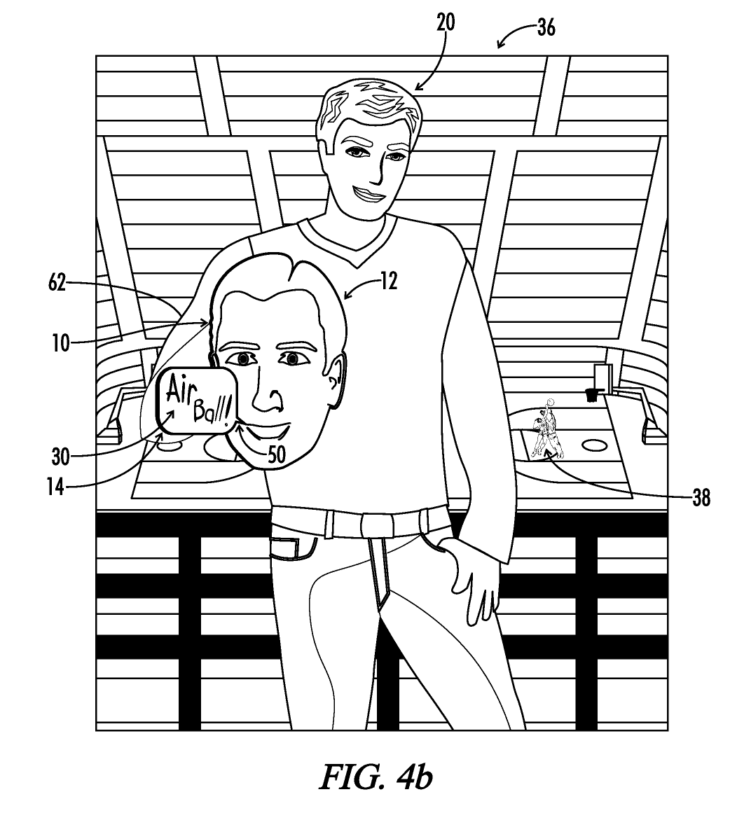

As illustrated in FIGS. 1 and 2, expression 14 can be changed. As best illustrated in FIGS. 4a and 4b, dry erase surface 34 allows holder 62 to write, remove, and/or change expression 14 in preparation of, during and in response to changes in real time at public events or private events or at the whim of the holder 62 or the person displaying the item. It is envisioned that real time means the actual time during which a process or event occurs or shortly thereafter. It is envisioned that public events include sporting events 36, entertainment in public places, rallies or other public gatherings, and similarly situated activities at venues. It is envisioned that private events include a welcome home, a gathering of friends and/or family, or other similarly situated activities at private locations.

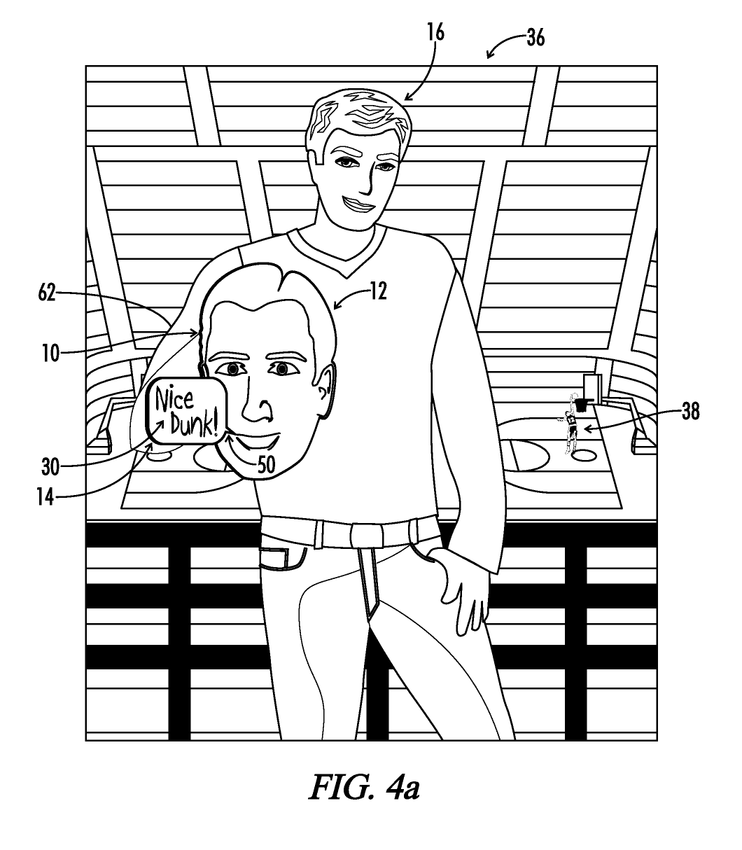

As best illustrated in FIG. 3, an embodiment of the present disclosure is image 12 of notable FIG. 16, such as the face of a sports star 38, that is affixed or printed on panel 40 (e.g., foam board or other backing material). An embodiment of the present disclosure is image 12 as previously described depicting notable FIG. 16, such as a person or entity 18, where the image is affixed or printed on panel 40.

Also affixed to panel 40, or image 12 itself is dry erase surface 34 that may depict expression of words, sentences, or thoughts, shaped for example, like a speech bubble, thought bubble, exclamation bubble. In another embodiment of the present disclosure, Expression area 30 is electronic. In yet another embodiment of the present disclosure, panel 40 includes in whole or in part of an erasable magnetic surface 32.

In an embodiment of the present disclosure, expression area 30 is mounted directly onto recessed region 42 of panel 40 as an inlay (being cut specifically to mate and lay flush with the remainder of panel 40 on which image 12 is mounted) wherever panel 40 is chosen to be placed. In another embodiment of the present disclosure panel 40 is affixed directly to image 12 already mounted upon the backing substrate material or partially directly on the image and supportive substrate material.

Dry erase surface 34 in the shape of a speech bubble has been partially affixed first to image 12 in such a way that the speech bubble appears to originate in the vicinity of the mouth of image 12. Bubble 50 illustrating expression 14 may be partially overhanging image 12, may be affixed to panel 40. Dry erase surface 34 is affixed to panel 40 that may be written on with dry erase marker 52 (FIG. 2) for writing/drawing different dialogues or thoughts or illustrations, and which may be wiped clean with dry eraser 54 (FIG. 2) or without dry eraser 54 (FIG. 2) by using other means, such as tissues, napkins, or cloth wipes.

In an embodiment of the disclosure, handle 60 is configured to hold expression image 10 by one hand of holder 62. Handle 60 may be as simple as Velcro™ strip 64 placed on the back of panel 40. As illustrated in FIG. 3, handle 60 is oriented to allow holder 62 to support panel 40 with one hand by placing their hand between panel 40 and handle 60 (FIG. 3). Expression image 10 may optionally include support 66 for dry erase marker 52 and/or dry eraser 54, where support 66 is also affixed to the back side of panel 40.

Working example of the disclosure:

As an example embodiment of the disclosure, expression image 10 includes image 12 of a famous athlete. Expression 14 is depicted on Expression area 30 to create an impression that the athlete depicted in image 12 is saying or thinking expression 14 on expression image 10.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

What is claimed is:

1. An article comprising:
an image of a figure, entity, or individual and
an expression area including a rewritable surface.

2. The article of claim 1 further comprising a panel supporting the image and the expression area, wherein the expression area is affixed to the panel.

3. The article of claim 2 wherein the expression area is detachable from the panel.

4. The article of claim 3 wherein the panel includes a magnetic surface.

5. The article of claim 1 wherein the expression area represents a speech bubble.

6. The article of claim 1 wherein the expression area represents a thought bubble or an exclamation bubble.

7. The article of claim 1 wherein the expression area represents a caption.

8. The article of claim 1 wherein the rewritable surface is erasable.

9. The article of claim 1 wherein the expression area includes an electronic display.

10. The article of claim 1 further comprising a dry erase marker or a dry eraser for use with the expression area.

11. A method comprising the steps of:
displaying an article including an image of a figure, entity, or individual, where the article also includes an expression area with a rewritable surface,
displaying the article at an event, where the figure, entity, or individual is participating in the event, and
expressing a sentiment in the expression area.

12. The method of claim 11 further comprising the step of:
expressing the sentiment in real-time relative to the event.

13. The method of claim 12 further comprising the step of:
erasing the sentiment.

14. The method of claim 13 further comprising the step of:
expressing a second sentiment on the article.

15. The method of claim 14 further comprising the step of:
displaying the second sentiment as activities change at the event.

16. The method of claim 11 further comprising the step of:
expressing the sentiment in preparation of changes in real time events.

17. The method of claim 11 further comprising the step of:
expressing the sentiment during changes in real time events or shortly thereafter.

18. The method of claim 11 further comprising the step of:
expressing the sentiment in response to changes in real time events.

19. The method of claim 11 further comprising the step of:
changing the sentiment in preparation of changes in real time events.

20. The method of claim 11 where the event is a private event.
